(19) United States
(12) Patent Application Publication
(10) Pub. No.: US 2011/0227461 A1
(43) Pub. Date: Sep. 22, 2011

(54) System for Collecting Stray Energy

(75) Inventor: Michael J. Blauberg, Ormondb, FL (US)

(73) Assignee: CURRENT RECOVERY LLC, Humble, TX (US)

(21) Appl. No.: 13/151,832

(22) Filed: Jun. 2, 2011

Related U.S. Application Data
(63) Continuation of application No. 12/215,756, filed on Jun. 30, 2008, now abandoned.

(51) Int. Cl. H02K 11/00; G01J 1/42

(52) U.S. Cl. 310/68 D; 250/227.11

(57) ABSTRACT

A converter system for generating electrical signal from an optical signal utilizes a collector for collecting an energy source as an optical signal. The collected optical signal is transmitted to a receiver which is associated with a converter for converting the optical signal to an electric signal. In one embodiment the converter system is incorporated in an electric motor of the type having a housing, a rotating shaft mounted in the housing, a commutator on the shaft, and a pair of permanent magnets, whereby the shaft is rotated in response to electrical power being applied to the commutator. The system includes an optical collector mounted in the housing in non-interfering relationship with the commutator and the shaft, whereby the optical collector is adapted for generating an optical signal from the stray energy in the motor housing when power is applied to the motor and the shaft is rotating. The optical signal thus generated is transmitted to the receiver.

### BACKGROUND OF THE INVENTION

1. Field of the Invention

The invention is generally related to energy conservation and is specifically directed to a system for collecting lost or stray energy and converting it into electrical energy.

2. Discussion of the Prior Art

Electric motors are well known devices. While such motors have become more efficient over the years, all motors are by nature less than one hundred percent efficient. The unused portion of the energy provided by the power source to the motor is generally dissipated as heat. This is true of other electrical devices as well. None of them can operate at one hundred percent efficiency. For example, the power drop in copper cable over long distances has always been a concern.

It is desirable to capture and utilize the dissipated or wasted energy as a means for enhancing the efficient use of power from the source. In the past examples of this has been conversion of the heat to steam which has many uses. Other uses are known as well.

However, to date there is not any example of collection of dissipated or wasted energy back to its original form whereby it can be looped back to the power source for use by the device or transmitted independently for use, reducing consumption of the original power from the source.

As the costs of energy continue to rise and as environmental issues caused by the generation of energy cause increasing concern, it becomes increasingly desirable to reduce not only the waste but also the byproducts of energy consumption.

### SUMMARY OF THE INVENTION

The subject invention is directed to an apparatus for collecting the dissipated waste from an electrically driven device such as a motor and converting it back into electrical energy for return to the source or for independent transmission. In its broadest form, the wasted or dissipated energy from the device is collected as an optical signal and converted from an optical signal to an electrical signal which may be returned to the source.

As an example, an electrical motor releases unused or stray energy. By winding the interior cavity of the motor with optical cable, the energy can be collected as optical energy instead of dissipated as heat. It is believed this occurs because the magnetic field normally found in the rotating motor, coupled with the energy released by the motor, excites the optical conduit, creating an optical signal. This optical signal may then be transmitted to a converter for converting the optical signal into an electrical signal which may be transmitted in the normal manner, either back to the source or for other uses.

The invention also establishes the use of an optical conduit for transmitting electrical power by permitting an optical signal from any source to be converted into electrical power. This has significant advantages in many applications. For example, it has been known for many years that there is very little signal degradation in an optical cable. This permits transmission of power over long distances with minimal voltage drop. Also, by transmitting the signal as an optical signal the danger electricity poses is eliminated. This would be useful in many applications, such as, by way of example, underwater transmission. As much as a 200 volt signal at 200 amps has been converted and transmitted in a ⅛ inch fiber optic cable for a distance of 125 feet. This is the equivalent of a 20 copper cable.

The invention can also be used to enhance the efficiency of electrical transmission. For example, by winding a standard transmission line such as copper cable with the optic collector of the subject invention much of the power drop due to the resistance in the cable can be recaptured as an optical signal and converted back into electrical energy.

The subject invention is a novel and useful system for collecting wasted or stray electrical energy as optical energy from a first source, whether it is capturing the energy previously dissipated as heat from an electrical motor or whether it is from another source, transmitting it as an optical signal to a remote location and converting it to electrical power. The invention is also useful for transmitting electrical power over a distance by first converting it to an optical signal at a source and then reconverting it to an electrical signal at a load.

In the preferred embodiment the optical signal is received by a converter. The converter comprises an array of titanium wafers which are imbedded in silicon. The optical collector is attached to one of the wafers. A pair of conductive foil strips are attached directly to the array of wafers and an electrical signal can be collected from the strips via couplers attached to the strips at the end of the strips opposite the position of the optical collector.

In its preferred form the invention is a converter system for generating electrical signal from an optical signal by utilizing a collector for collecting an energy source as an optical signal. The collected optical signal is transmitted to a receiver which is associated with a converter for converting the optical signal to an electric signal. In one embodiment the converter system is incorporated in an electric motor of the type having a housing, a rotating shaft mounted in the housing, a commutator on the shaft, and a pair of permanent magnets, whereby the shaft is rotated in response to electrical power being applied to the commutator. The system includes an optical collector mounted in the housing in non-interfering relationship with the commutator and the shaft, whereby the optical collector is adapted for generating an optical signal from the stray energy in the motor housing when power is applied to the motor and the shaft is rotating. The optical signal thus generated is transmitted to the receiver.

The converter system of the subject invention is connected to a source of an optical signal. The signal is collected and transmitted to the converter. In its preferred from the converter includes at least one elongated plate physically connected to the collector and adapted to be excited by the optical signal to produce an electrical signal. A pair of couplers attached to opposite ends of the plate for receive the electric signal generated in the plate and transmit it from the converter to a remote location. In the preferred embodiment the plate is a titanium wafer which is embedded in silicon. The converter includes a non-conductive base, and one elongated edge of the plate is mounted on the non-conductive base with the other elongated edge is extending beyond the silicon which embeds the plate. Typically, a plurality of plates are mounted in the base in a parallel array and the couplers comprise a pair of elongated conductive foil strips, each in contact with all of the plates.

### BRIEF DESCRIPTION OF THE DRAWINGS

FIG. 1 is a flow chart of the circuitry in accordance with the teachings of the subject invention.

FIG. 2 is a sectional view of an electric motor as modified with the current recovery system of the subject invention.

FIG. 3 is a longitudinal sectional view of the motor shown in FIG. 2.

FIG. 4 is an overview of the current recovery converter circuitry.

FIG. 5 is a perspective view of a converter circuit in accordance with the teachings of the subject invention.

### DETAILED DESCRIPTION OF THE PREFERRED EMBODIMENTS

The subject invention is, in the broadest sense, a transmission system for first converting a source of energy into an optical signal for transmission and then converting it into an electrical signal at a remote location. The source energy may be an electrical signal, such as in a transmission line, and electrical source such as a generator, or stray or lost energy such lost power typically dissipated as heat in an electric motor or the like. For purposes of discussion the description of collection of energy in an electrical motor is described in detail herein. However, it should be understood that any source of energy which can be used to excite an optical device can provide a source for the optical signal which is then converted into an electrical signal at a remote location.

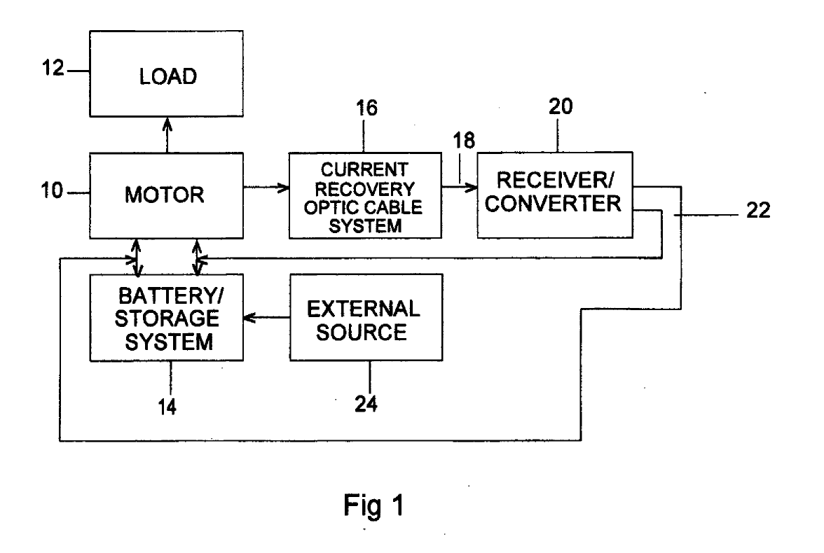

The subject invention works with either a standard AC or DC electric motor and is adapted for recovering as electric energy the losses generated in normal operation of the motor. A flow diagram of the system is shown in FIG. 1. As there shown, an electric motor 10 is connected to a load 12 in the well known manner. The motor derives its power from a power source such as the battery storage system 14.

All motors operate at less than 100% efficiency and the lost power is generally dissipated as heat. The recovery system of the subject invention utilizes the normal magnetic fields of the operating motor and the stray energy to excite an optical recovery system rather than be dissipated as heat, as indicated at 16. Basically, and as will further described herein, an optical collection system 16 is mounted in the motor. The optical collection system generates an optical signal, as indicated at 18 by utilizing the stray energy generated by the motor and exciting an optical collector utilizing the normal magnetic field present in an operating motor. A receiver/converter 20 collects the optical signal and coverts it to electrical energy as indicated at 22. The electrical energy is then looped back to the power source, such as the battery storage system 14. It should be understood that the power source may be any configuration or source. The battery storage system is used only for purposes of illustration. As is well known to those who are skilled in the arts, the battery storage system may be rechargeable via an external source 24.

The recovery system of the subject invention recycles a substantial portion of the energy lost or dissipated in the normal running of an electrical motor by collecting this energy and channeling it back into the power source or power side of the circuitry. In the preferred embodiment the recovery system uses an optical conduit such as, by way of example, an optic cable that is wound around the electrical device for transmitting an optical signal to a converter for converting the optical signal into electrical energy. The electrical energy thus captured is returned to the power source side of the device.

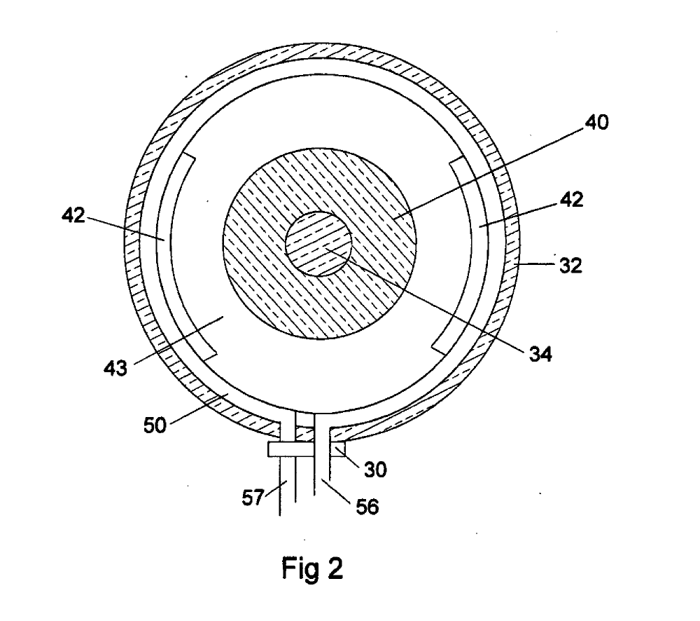

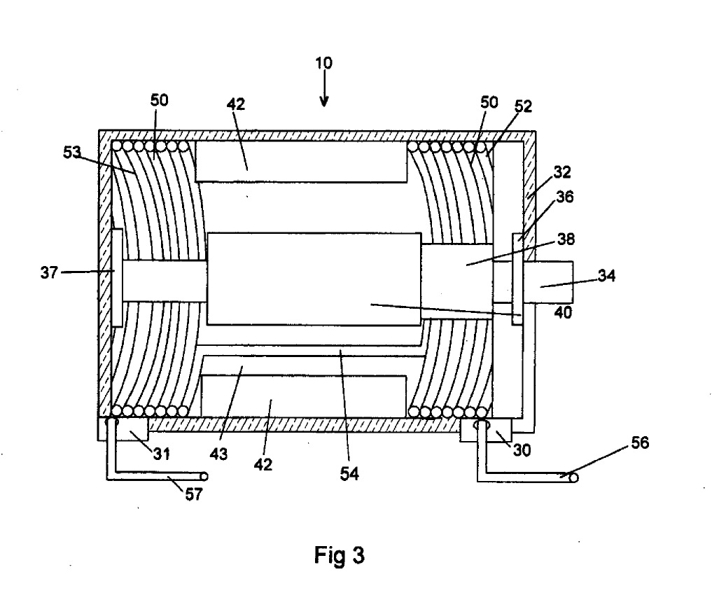

With reference to FIGS. 2 and 3, a typical electric motor 10 is shown, with the optical signal 18 exiting from the motor through insulators 30, 31. In typical fashion, the motor consists of a housing 32 with an elongated shaft 34 extending the length of the housing and mounted for rotation in the motor bearings 36, 37. A commutator 38 is mounted on the shaft. The motor shaft winding is indicated at 40. Permanent magnets 42, 43 are mounted in the housing. The battery power is connected to the commutator 38, typically by brushes, not shown. It should be understood that the invention works equally well with brushless motors and with both AC and DC electric motors.

The optical collector system of the preferred embodiment comprises an unshielded optical cable 50 which is spirally wound along the inside wall of the motor housing, outboard of the magnets 42, 43, as best shown in FIG. 3. The cable is continuous and the two winding components 52, 53 are connected by a cable run 54 extending between the two winding components. An outer end 56 of the winding 52 passes through the housing 32 at insulator 30. An outer end 57 of the winding 53 passes through the housing at insulator 31. Together the ends 56, 57 form the optical conduit 18. As the motor rotates in typical operation, the optical windings are excited, generating an optical signal in the unshielded optical cable. This signal is then discharged from the motor via the optical conduit 18.

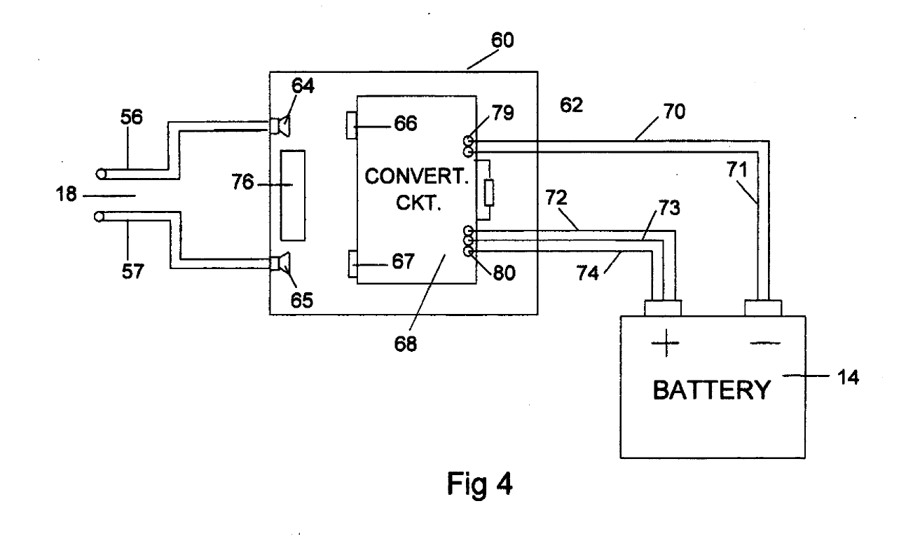

The optical signal on optical conduit 18 is introduced into a converter system 60, as shown in FIG. 4. The system is mounted on a non-conductive base 62. A pair of light emitters 64, 65 are connected to the respective ends 56, 57 of the optical conduit The emitters transmit the optical signal to a pair of complementary collectors 66, 67 which are mounted on the converter circuit module 68. The converter circuit converts the optical signal to an electrical signal which is discharged into the electrical conduit components comprising electrically conductive wires 70, 71, 72, 73, 74. The electrical conduit then transmits the electrical signal back to the battery or other source, as indicated at 22. In the example, the wires 70, 71 are negative whereas the wires 72, 73, 74 are positive.

In the preferred embodiment a permanent magnet 76 is positioned between the two emitters 64, 65. An arc suppression diode 78 is mounted between the positive and negative output posts 79, 80 on the converter circuit.

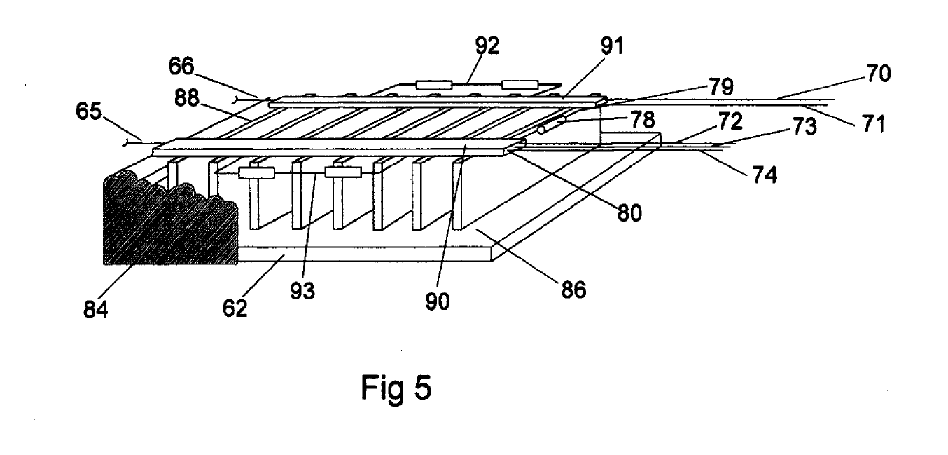

The converter circuit module 68 is shown in detail in FIG. 5. As shown, a plurality of titanium wafers 84 are mounted in substantially parallel, spaced apart relationship on the non-conductive base 62. The wafers are embedded in a silicon encasement 86, with the top edge 88 of each wafer being exposed. The collectors 65, 66 are connected at opposite ends to the first wafer in the series. A pair of conductive foil strips 90, 91 are connected to the top edge of each wafer at opposite ends as shown. A capacitor resistor circuit 92, 93 is connected in parallel with the respective strips 90, 91. The output posts 79, 80 are connected to the strips at the end opposite the collectors 65, 66.

The optical energy is collected at collectors 65, 66, which are connected directly to the first of the wafers 84. The wafer array is then stimulated to produce electrical energy which is output at the output posts 79, 80 into wires 70, 71, 72, 73, 74 for transmission to the battery.

The invention also establishes the use of an optical conduit for transmitting electrical power by permitting an optical signal from any source to be converted into electrical power. This has significant advantages in many applications. For example, it has been known for many years that there is very little signal degradation in an optical cable. This permits transmission of power over long distances with minimal voltage drop. Also, by transmitting the signal as an optical signal the danger electricity poses is eliminated. This would be useful in many applications, such as, by way of example, underwater transmission. As much as a 200 volt signal at 200 amps have been converted and transmitted in a ⅛ inch fiber optic cable for a distance of 125 feet. This is the equivalent of a 20 copper cable.

The subject invention is a novel and useful system for collecting power as optical energy from a first source, whether it is stray energy generally dissipated as heat in an electrical motor or whether it is another source, transmitting it as an optical signal to a remote location and converting it to electrical power. In the preferred embodiment the optical signal is received by a converter. The converter comprises an array of titanium wafers which are imbedded in silicon. The optical collector is attached to one of the wafers. A pair of conductive foil strips are attached directly to the array of wafers and an electrical signal can be collected from via couplers attached to the strips at the end of the strips opposite the position of the optical collector.

While certain embodiments and features of the invention have been described in detail herein it will be understood that the invention includes all enhancements and modifications within the scope and spirit of the following claims.

1. A fiber optic collection apparatus for collecting energy from a source of energy without physically contacting the source of energy, the fiber optic collection apparatus comprising:
a. A fiber optic collector for collecting energy released from the source as an optical signal;
b. A receiver for receiving the optical signal;
c. A fiber optic transport conduit for transporting the optical signal from the collector to the receiver;
d. A converter associated with the receiver for converting the optical signal to an electric signal;
e. A remote storage device adapted for storing electric energy; and
f. An electrical conduit for transmitting the electrical signal to the remote storage device.

4. The apparatus of claim 1, wherein the energy source is primarily stray energy previously dissipated as heat.

5. The apparatus of claim 1, wherein the collector is an optical device adapted to be excited by an external source for generating an optical signal.

6. The apparatus of claim 5, wherein the optical device is optic cable.

7. The apparatus of claim 1, wherein the converter further comprises:
a. a collector for receiving the optical signal;
b. at least one elongated plate physically connected to the collector and adapted to be excited by the optical signal to produce an electrical signal; and
c. a pair of couplers attached to opposite ends of the plate for receiving the electric signal generated in the plate.

8. The apparatus of claim 7, wherein the plate is a titanium wafer.

9. The apparatus of claim 8, wherein the plate is embedded in silicon, and wherein the converter further includes a non-conductive base, and wherein one elongated edge of the plate is mounted on the non-conductive base and the other elongated edge is extending beyond the silicon which embeds the plate.

10. The apparatus of claim 9, further including a plurality of plates mounted in the base in a parallel array and wherein the couplers comprise a pair of elongated conductive foil strips, each in contact with all of the plates.

11. An electric motor of the type having a housing, a rotating shaft mounted in the housing, a commutator on the shaft, and a pair of permanent magnets, whereby the shaft is rotated in response to electrical power being applied to the commutator, the motor further comprising:
a. a fiber optic collector mounted in the housing in non-interfering relationship with the commutator and the shaft, whereby the optical collector is adapted for generating an optical signal from the stray energy in the motor housing when power is applied to the motor and the shaft is rotating;
b. a fiber optic conduit for transmitting the optical signal from the motor;
c. a receiver remote from the motor and in communication with the fiber optic conduit for receiving the optical signal external of the motor;
d. a converter in association with the receiver for converting the optical signal into an electrical signal;
e. a remote electrical storage device; and
f. an electrical conduit for transmitting the electrical signal from the converter to the remote electrical storage device.

14. The motor of claim 11, wherein the converter further comprises:
a. a collector for receiving the optical signal;
b. at least one elongated plate physically connected to the collector and adapted to be excited by the optical signal to produce an electrical signal; and
c. a pair of couplers attached to opposite ends of the plate for receiving the electric signal generated in the plate.

15. The apparatus of claim 14, wherein the plate is a titanium wafer.

16. The apparatus of claim 14, wherein the plate is embedded in silicon, and wherein the converter further includes a non-conductive base, and wherein one elongated edge of the plate is mounted on the non-conductive base and the other elongated edge is extending beyond the silicon which embeds the plate.

17. The apparatus of claim 16, further including a plurality of plates mounted in the base in a parallel array and wherein the couplers comprise a pair of elongated conductive foil strips, each in contact with all of the plates.
